(19) United States
(12) Patent Application Publication
(10) Pub. No.: US 2025/0088621 A1
(43) Pub. Date: Mar. 13, 2025

(54) SYSTEM FOR EVALUATING DISPLAY DEVICE AND METHOD FOR EVALUATING DISPLAY DEVICE USING THE SAME

(71) Applicant: Samsung Display Co., LTD., Yongin-si (KR)

(72) Inventors: Young Min PARK, Yongin-si (KR); Jae Joong KWON, Yongin-si (KR); Jin SEO, Yongin-si (KR); A Ree SONG, Yongin-si (KR); Eun Jung LEE, Yongin-si (KR)

(73) Assignee: Samsung Display Co., LTD., Yongin-si (KR)

(21) Appl. No.: 18/823,931

(22) Filed: Sep. 4, 2024

(30) Foreign Application Priority Data
Sep. 8, 2023 (KR) 10-2023-0119681

(51) Int. Cl. H04N 13/327; H04N 13/125; H04N 13/305; H04N 13/398

(52) U.S. Cl. CPC H04N 13/327; H04N 13/125; H04N 13/398; H04N 13/305

(57) ABSTRACT

A system for evaluating a display device includes a display device including a display panel outputting pattern images for viewpoints and a lens array refracting the pattern images, and a luminance meter generating a luminance profile by capturing the pattern images. Each of the pattern images includes a pattern.

### CROSS-REFERENCE TO RELATED APPLICATION(S)

This application claims priority to and the benefits of Korean Patent Application No. 10-2023-0119681 under 35 U.S.C. § 119, filed on Sep. 8, 2023, in the Korean Intellectual Property Office (KIPO), the entire contents of which are incorporated herein by reference.

### BACKGROUND

### 1. Technical Field

The disclosure relates to a system for evaluating a display device and a method for evaluating a display device using the same.

### 2. Description of the Related Art

As information technology develops, the importance of a display device as a connection medium between a user and information is being emphasized. In response to this, the use of display devices such as a liquid crystal display device and an organic light emitting display device is increasing.

A stereoscopic image display device is a display device that stimulates the viewer's visual senses like a real object and provides physical factors to perceive an image in three dimensions. For example, the stereoscopic image display device may provide different images to the left and right eyes of a viewer so that the viewer can view a stereoscopic image due to binocular parallax between the left and right eyes.

Recently, studies on an autostereoscopic method in which stereoscopic glasses are not worn have been actively conducted. The autostereoscopic method may include a lenticular method for separating left and right eye images using a cylindrical lens array, a barrier method for separating left and right eye images using a barrier, and the like.

An autostereoscopic display device may form a light field composed of multiple viewpoints. In this case, crosstalk may be generated in which each viewpoint partially overlaps adjacent viewpoints. In addition, in case that a viewer does not view the image on the display device at an optimal viewing distance, distortion may be generated in the stereoscopic image.

The above description is only for helping the understanding of the background art for the technical ideas of the disclosure. Therefore, it should not be understood as the contents corresponding to the prior art known to those skilled in the art to which the disclosure pertains.

### SUMMARY

A technical problem to be solved by the disclosure is to provide a system for evaluating a display device and a method for evaluating a display device using the same that shortens the time for evaluating a display device that outputs an image corresponding to multiple viewpoints.

According to an embodiment of the disclosure, a system for evaluating a display device may include a display device including a display panel outputting pattern images for viewpoints and a lens array refracting the pattern images, and a luminance meter generating a luminance profile by capturing the pattern images. Each of the pattern images may include a pattern.

The pattern images may include the pattern at different positions.

The pattern images may include a first pattern image including a first pattern and a second pattern image including a second pattern, the first pattern may overlap a virtual reference pattern defined in the pattern images, and the second pattern may be spaced apart from the virtual reference pattern by a first distance in a direction.

The pattern images may further include a third pattern image including a third pattern, and the third pattern may be spaced apart from the virtual reference pattern in the direction by a second distance greater than the first distance.

The pattern may have a line shape.

The luminance meter may include a main controller measuring crosstalk generated by the display panel based on the luminance profile.

The main controller may extract a luminance profile graph corresponding to the luminance profile, and measure the crosstalk based on a ratio of an area and another area other than the area in the luminance profile graph.

The area may include a point where luminance is maximum in the luminance profile graph, and the crosstalk may decrease as the area increase.

The main controller may measure a degree of distortion in the pattern images output by the display panel based on the luminance profile.

The main controller may extract luminance profile graphs corresponding to the luminance profile, and measure the degree of distortion based on a distance between a point where luminance is maximum in one of the luminance profile graphs and a point where luminance is maximum in another adjacent one of the luminance profile graphs.

The degree of distortion may increase as the distance increases.

The system for evaluating the display device may further include a moving member moving the luminance meter from the display panel.

According to an embodiment of the disclosure, a method for evaluating a display device may include outputting pattern images for viewpoints by a display panel; generating a measured image by capturing the pattern images refracted by a lens array disposed on the display panel; and generating a luminance profile based on the measured image. Each of the pattern images may include a pattern.

The pattern images may include the pattern at different positions.

The pattern images may include a first pattern image including a first pattern and a second pattern image including a second pattern, the first pattern may overlap a virtual reference pattern defined in the pattern images, and the second pattern may be spaced apart from the virtual reference pattern by a first distance in a direction.

The pattern images may further include a third pattern image including a third pattern, and the third pattern may be spaced apart from the virtual reference pattern in the direction by a second distance greater than the first distance.

The method for evaluating the display device may further include measuring crosstalk generated by the display panel based on the luminance profile.

The measuring of the crosstalk may include extracting a luminance profile graph corresponding to the luminance profile, and measuring the crosstalk based on a ratio of an area and another area other than the area in the luminance profile graph.

The method for evaluating the display device may further include measuring a degree of distortion in the pattern images output by the display panel based on the luminance profile.

The measuring of the degree of distortion in the pattern images may include extracting luminance profile graphs corresponding to the luminance profile; and measuring the degree of distortion based on a distance between a point where luminance is maximum in one of the luminance profile graphs and a point where luminance is maximum in another adjacent one of the luminance profile graphs.

### BRIEF DESCRIPTION OF THE DRAWINGS

The accompanying drawings, which are included to provide a further understanding of the disclosure, and are incorporated in and constitute a part of this specification, illustrate embodiments of the disclosure, and, together with the description, serve to explain principles of the disclosure.

FIG. 1 is a schematic diagram for explaining a lens array type stereoscopic image display device.

FIG. 2 is a schematic diagram for explaining the relationship between a lens array and a display panel.

FIG. 3 is a schematic diagram for explaining the relationship between a luminance meter and a display device according to an embodiment of the disclosure.

FIG. 4 is a schematic block diagram illustrating an embodiment of the luminance meter of FIG. 3.

FIGS. 5A to 5E are schematic diagrams illustrating pattern images output from a display panel of FIG. 3.

FIG. 6 is a schematic diagram illustrating a measured image at a k-th viewpoint generated by capturing pattern images by the luminance meter of FIG. 3.

FIG. 7 is a graph illustrating a luminance profile of the measured image of FIG. 6.

FIG. 8 is a schematic diagram illustrating a state in which the luminance meter of FIG. 3 has been moved from the display panel.

FIG. 9 is a flowchart illustrating a method for evaluating a display device according to an embodiment of the disclosure.

FIG. 10 is a flowchart illustrating a method for evaluating a display device according to another embodiment of the disclosure.

FIG. 11 is a flowchart illustrating a method for evaluating a display device according to still another embodiment of the disclosure.

### DETAILED DESCRIPTION OF THE EMBODIMENTS

Hereinafter, an embodiment according to the disclosure is described in detail with reference to the accompanying drawings. It should be noted that in the following description, only portions necessary for understanding an operation according to the disclosure are described, and descriptions of other portions are omitted in order not to obscure the subject matter of the disclosure. In addition, the disclosure may be embodied in other forms without being limited to the embodiment described herein. However, the embodiment described herein is provided to describe in detail enough to readily implement the technical spirit of the disclosure to those skilled in the art to which the disclosure belongs.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Terms used herein are for describing specific embodiments and are not intended to limit the disclosure. The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

Various embodiments are described with reference to drawings schematically illustrating ideal embodiments. Accordingly, it will be expected that shapes may vary, for example, according to tolerances and/or manufacturing techniques. Therefore, the embodiments disclosed herein cannot be construed as being limited to shown specific shapes, and should be interpreted as including, for example, changes in shapes that occur as a result of manufacturing. As described above, the shapes shown in the drawings may not show actual shapes of areas of a device, and the disclosure is not limited thereto.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

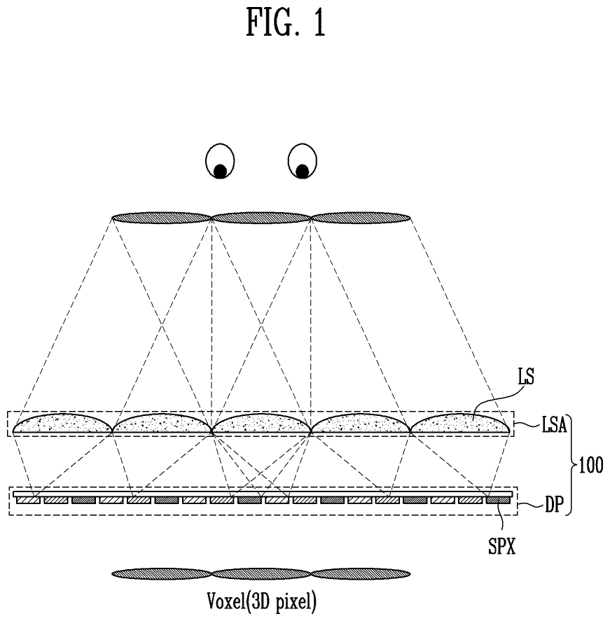

FIG. 1 is a schematic diagram for explaining a lens array type stereoscopic image display device.

Referring to FIG. 1, a display device 100 may include a display panel DP and a lens array LSA.

The display panel DP may include sub-pixels SPX that emit light to display an image. In an embodiment, each of the sub-pixels SPX may output one of light of a first color (for example, red), light of a second color (for example, green), and light of a third color (for example, blue). However, the color of light emitted from the sub-pixels SPX is not limited thereto. Light of various colors for realizing full-color may be output. The display panel DP may include an organic light emitting display panel, a liquid crystal display panel, a quantum dot display panel, or the like.

The lens array LSA may be disposed on the display panel DP and may include lenses LS that refract light incident from the sub-pixels SPX. For example, the lens array LSA may be implemented as a lenticular lens array, a micro lens array, or the like.

A light field display may be a 3D display device that implements a stereoscopic image by forming a light field expressed as a vector distribution (intensity, direction) of light in space using a flat panel display and an optical element (for example, the lens array LSA). The light field display may implement a more natural stereoscopic image because a viewer can see the depth and sides of an object, and may be a display technology that is expected to be used in various ways through convergence with AR (Augmented Reality) technology, etc.

The light field may be implemented in several methods. For example, the light field may be formed by a method to create multi-directional light fields using multiple projectors, a method of controlling the direction of light using a diffraction grating, a method of adjusting the direction and intensity (luminance) of light according to the combination of each pixel using two or more panels, a method for controlling the direction of light using a pinhole or barrier, a method for controlling the direction in which light is refracted through a lens array, or the like.

In an embodiment, as shown in FIG. 1, the lens array type stereoscopic image display device 100 may display a stereoscopic image (3D image) by forming the light field.

A series of sub-pixels SPX may be assigned to each lens LS. Light emitted from each of the sub-pixels SPX may be refracted by the lens LS and proceed only in a specific direction to form a light field represented by light intensity and direction. In case that a viewer looks at the display device 100 in the light field formed as described above, the viewer may feel a three-dimensional effect of a corresponding image.

Image information according to the viewpoint of the viewer in the light field may be defined and processed in units of voxels. A voxel may be graphic information defining a point (or pixel) in a 3D space.

The resolution of a 2D image may be determined by the number of pixels (for example, density) in the same area. For example, in case that the number of pixels increases in the same area, the resolution may increase. For example, the display panel DP having a high pixel density may be required for a high-resolution image. Similarly, in case that the number of voxels at the same viewpoint through the lens array LSA increases, the resolution of a stereoscopic image may increase.

The display panel DP may be applied to electronic devices such as a smartphone, television, a tablet PC, a mobile phone, a video phone, an e-book reader, a desktop PC, a laptop PC, a netbook computer, a workstation, a server, a PDA, a portable multimedia player (PMP), ad MP3 player, a medical device, a camera, or a wearable device.

According to an embodiment, the display panel DP may also be applied to a head mounted display device. Devices to which the display panel DP is applied are not limited to the examples described above, and the display panel DP may be applied to an electronic device having a display screen on at least one side.

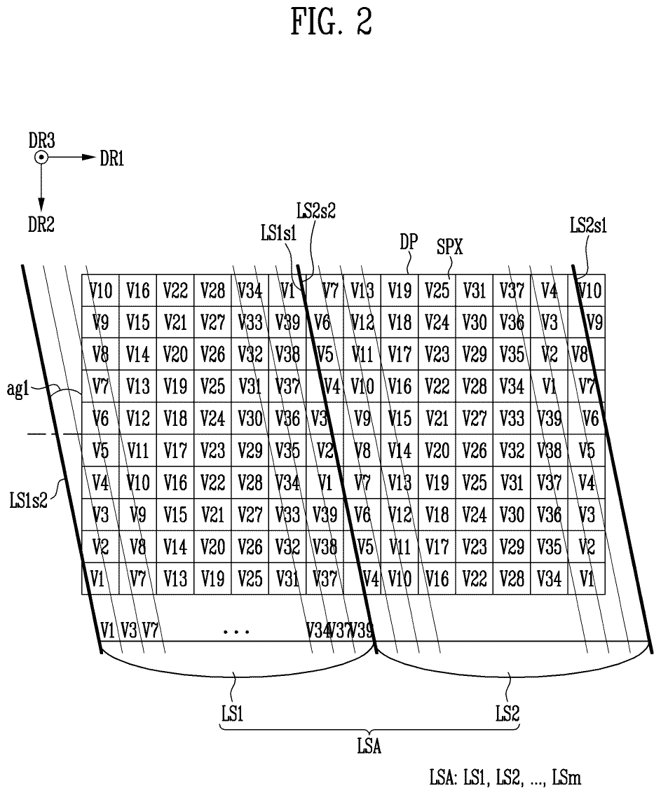

FIG. 2 is a schematic diagram for explaining the relationship between a lens array and a display panel.

Referring to FIG. 2, the display panel DP may include the sub-pixels SPX arranged in a first direction DR1 and a second direction DR2 intersecting the first direction DR1. The sub-pixels SPX may include light emitting surfaces in a third direction DR3 intersecting the first direction DR1 and the second direction DR2.

Each of the sub-pixels SPX may include a light emitting element configured to emit light. The light emitting element may be provided in various forms. For example, the light emitting element may be an inorganic light emitting element including an inorganic material. According to an embodiment, the light emitting element may be an organic light emitting diode (OLED).

Each of the sub-pixels SPX may be a first pixel configured to emit red light, a second pixel configured to emit green light, or a third pixel configured to emit blue light.

The lens array LSA may include lenses LS1, LS2, . . . , and LSm, where m may be a natural number. The lenses LS1 to LSm may be lenticular lenses.

The lenses LS1 to LSm may overlap the sub-pixels SPX in the third direction DR3. The lenses LS1 to LSm may be arranged such that their long sides have an angle ag1 greater than 0 degrees with respect to the second direction DR2. For example, a first lens LS1 may include a first long side LS1s1 and a second long side LS1s2 that are parallel to each other. Also, a second lens LS2 may include a first long side LS2s1 and a second long side LS2s2 that are parallel to each other. The lenses LS1 to LSm may be arranged in the first direction DR1. However, the disclosure is not limited thereto, and in another embodiment, the angle ag1 may be 0 degrees.

A lower surface (a surface facing the sub-pixels SPX) of each of the lenses LS1 to LSm may be partitioned into multiple viewpoint areas V1 to V39. The viewpoint areas V1 to V39 may not be physically partitioned, but may be virtual areas, and may be defined in various ways according to the resolution of the display panel DP, the specifications of the lenses LS1 to LSm, the number of viewpoints to be provided to a user, and the like. Each of the lenses LS1 to LSm may distribute images corresponding to each of the viewpoint areas V1 to V39 in different directions (different viewpoints), so that the user may visually recognize a multi-view image in which images varies depending on the location.

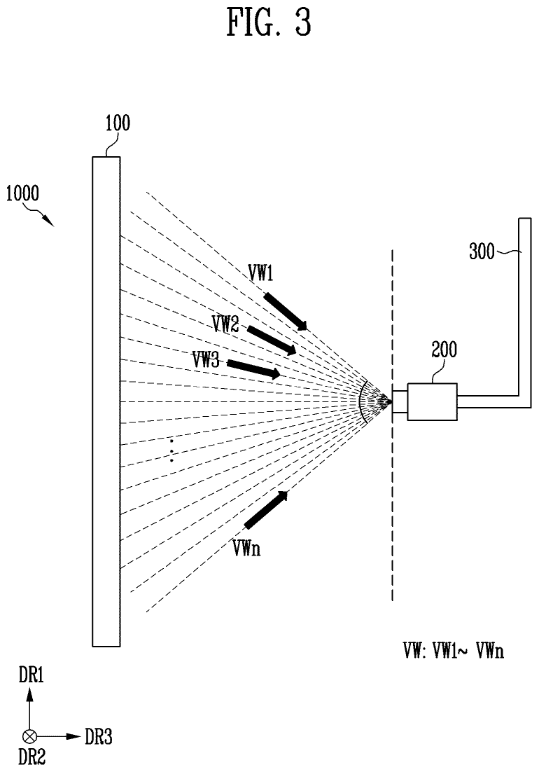

The sub-pixels SPX may overlap one or more of the viewpoint areas V1 to V39 in the third direction DR3. FIG. 2 shows major viewpoint areas V1 to V39 corresponding to the sub-pixels SPX. Sub-pixels SPX corresponding to the same viewpoint area may display an image for the same viewpoint VW (see FIG. 3). Accordingly, as shown in FIG. 2, in case that there are 39 viewpoint areas V1 to V39, the display panel DP may display 39 images simultaneously.

According to an embodiment, the display device 100 may display a stereoscopic image by displaying a right-eye image using sub-pixels SPX overlapping viewpoint areas V1 to V20 and displaying a left-eye image using sub-pixels SPX overlapping viewpoint areas V21 to V39 in the third direction DR3. The user of the display device 100 may be positioned so that the left-eye image is visually recognized by the left eye and the right-eye image is visually recognized by the right eye.

The sub-pixels SPX may be arranged in various structures such as RGB stripe, Diamond Pixel™, S-stripe, Real RGB, normal PENTILE™, and the like.

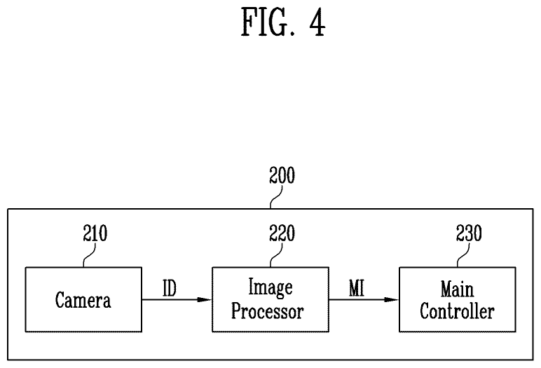

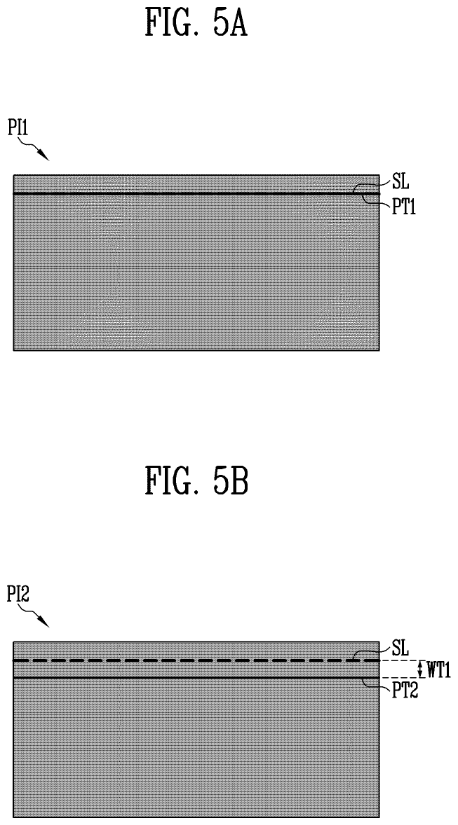

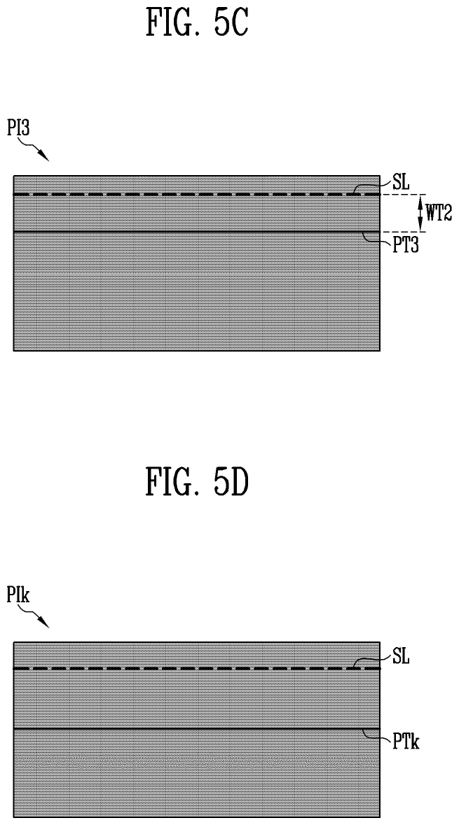

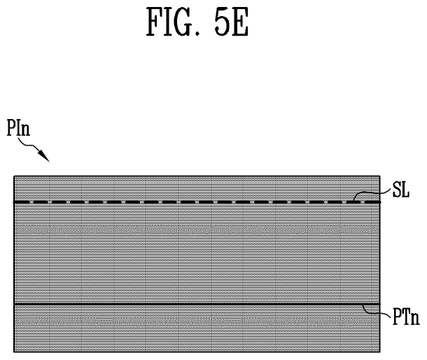

FIG. 3 is a schematic diagram for explaining the relationship between a luminance meter and a display device according to an embodiment of the disclosure. FIG. 4 is a schematic block diagram illustrating an embodiment of the luminance meter of FIG. 3. FIGS. 5A to 5E are schematic diagrams illustrating pattern images output from a display panel of FIG. 3.

Referring to FIG. 3, a system 1000 for evaluating a display device according to an embodiment of the disclosure may include the display device 100, a luminance meter 200, and a moving member 300.

Referring to FIGS. 5A to 5E together, the display device 100 may output pattern images PI1, PI2, . . . . PIK, . . . , and PIn for viewpoints VW. For example, pattern images PI1, PI2, . . . . PIk, . . . , and PIn may correspond to viewpoints VW1 to VWn, respectively, where k and n may be natural numbers and n>k. Accordingly, a first pattern image PI1 may be an image corresponding to a first viewpoint VW1, a k-th pattern image PIk may be an image corresponding to a k-th viewpoint VWk, and an n-th pattern image PIn may be an image corresponding to an n-th viewpoint VWn. Accordingly, the display device 100 may display a multi-view image by outputting the pattern images PI1, PI2, . . . . PIk, . . . , and PIn.

The display panel DP (see FIG. 2) may include sub-pixel groups displaying each of the first to n-th pattern images PI1 to PIn. Among the sub-pixels SPX of the display panel DP, sub-pixels SPX overlapping a first viewpoint area V1 (see FIG. 2) in the third direction DR3 may be a first sub-pixel group, and the first sub-pixel group may output the first pattern image PI1. Also, among the sub-pixels SPX, sub-pixels SPX overlapping a 39th viewpoint area V39 (see FIG. 2) in the third direction DR3 may be a 39th sub-pixel group, and the 39th sub-pixel group may output a 39th pattern image PI39. According to an embodiment, n may be 39, and the display device 100 may include at least 39 sub-pixel groups.

The first to n-th pattern images PI1 to PIn may include patterns PT1 to PTn arranged at different positions. For example, the first pattern image PI1 may include a first pattern PT1 that overlaps a virtual reference line SL disposed at the top of the image in the third direction DR3. The second pattern image PI2 may include a second pattern PT2 spaced apart from the reference line SL by a first distance WT1. Also, the third pattern image PI3 may include a third pattern PT3 spaced apart from the reference line SL by a second distance WT2. In this way, the patterns PT1 to PTn may be disposed to be gradually spaced apart from the reference line SL from the first pattern PT1 to the n-th pattern PTn.

According to an embodiment, the patterns PT1 to PTn may have a line shape. However, the disclosure is not limited thereto as long as the pattern images PI1 to PIn can be distinguished.

Referring to FIG. 4, the luminance meter 200 may include a camera 210 that captures a multi-view image displayed by the display device 100. For example, the camera 210 may capture the first to n-th pattern images PI1 to PIn output by the display device 100 and corresponding to the first to n-th viewpoints VW1 to VWn.

According to an embodiment, the camera 210 may be a spectroradiometer or a multi-spectral camera, but the disclosure is not limited thereto as long as the camera 210 can measure the luminance of the multi-view image displayed by the display device 100.

The luminance meter 200 may include an image processor 220 that generates a measured image MI. For example, the image processor 220 may receive image data ID captured by the camera 210. The image processor 220 may generate the measured image MI based on the image data ID. For example, the image processor 220 may generate measured images MI1 to MIn corresponding to the viewpoints VW1 to VWn.

The luminance meter 200 may include a main controller 230 that generates a luminance profile. The main controller 230 may receive the measured image MI. The main controller 230 may generate the luminance profile based on the received measured image MI.

The moving member 300 may move the position of the luminance meter 200. For example, the luminance meter 200 may be connected to the moving member 300 and moved in the third direction DR3. Accordingly, a distance between the display device 100 and the luminance meter 200 may vary.

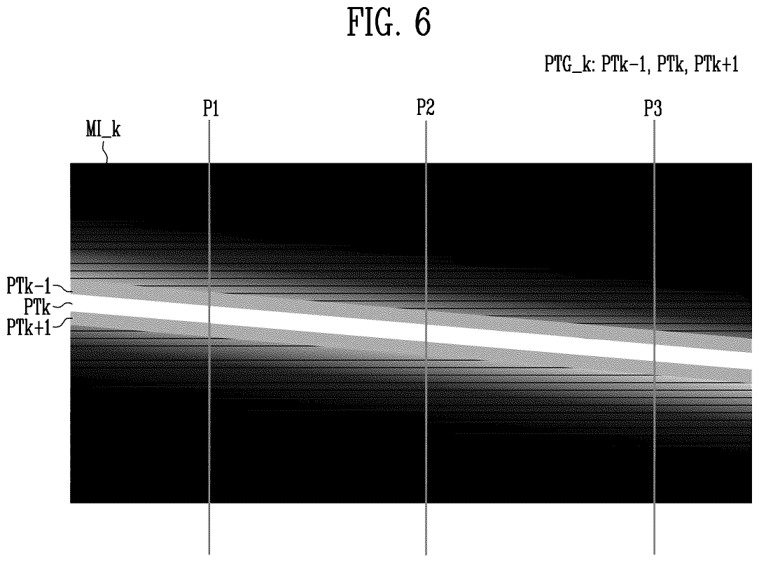

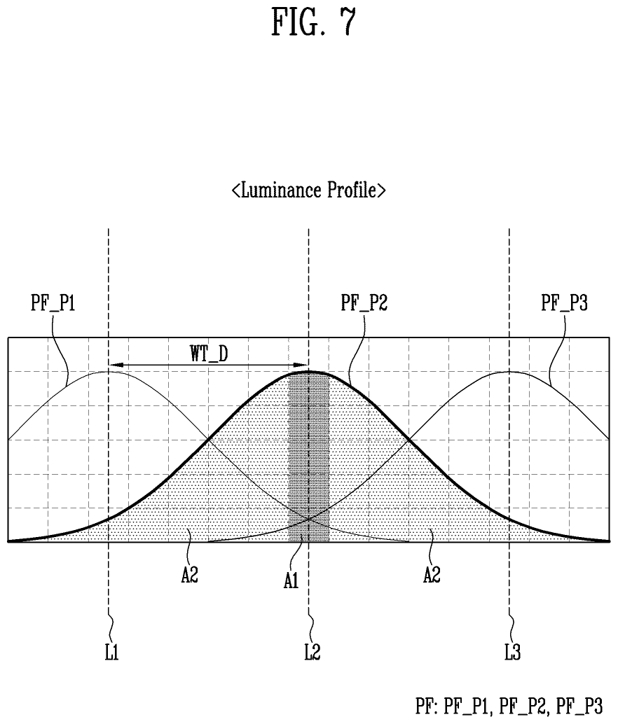

FIG. 6 is a schematic diagram illustrating a measured image at a k-th viewpoint generated by capturing pattern images by the luminance meter of FIG. 3. FIG. 7 is a graph illustrating a luminance profile of the measured image of FIG. 6.

Referring to FIG. 6, the luminance meter 200 may generate the measured image MI by capturing the pattern images PT1 to PTn output by the display device 100. For example, the luminance meter 200 may capture a k-th viewpoint VWk image expressed by the pattern images PT1 to PTn. Accordingly, a k-th measured image MI_k that is substantially the same as the image viewed by the user of the display device 100 at the k-th viewpoint VWk may be generated.

The measured image MI may include a pattern group PTG. For example, the k-th measured image MI_k may include a k-th pattern group PTG_k including a (k−1)th pattern PTk−1, a k-th pattern PTk, and a (k+1)th pattern PTk+1. However, the disclosure is not limited thereto, and the k-th pattern group PTG_k may include more patterns.

In an embodiment, the k-th pattern group PTG_k may include only the k-th pattern PTk. In another embodiment, the k-th pattern group PTG_k may include not only the k-th pattern PTk but also the (k−1)th pattern PTk−1 and/or the (k+1)th pattern PTk+1. For example, in case that the user of the display device 100 views the image corresponding to the k-th viewpoint VWk, not only light of the k-th pattern image PIk but also light of the (k−1)th pattern image PIk−1 and the (k+1)th pattern image PIk+1 may overlap each other. Accordingly, crosstalk may be generated in which not only the k-th pattern PTk but also the (k−1)th pattern PTk−1 and/or the (k+1)th pattern PTk+1 are visually recognized by the user. As such, crosstalk generated by the display device 100 may affect the visibility of the display device 100, so it may be desirable to accurately measure the crosstalk.

The pattern group PTG may have a slanted shape. For example, the pattern group PTG may have a shape inclined at an angle from a horizontal direction.

The k-th pattern group PTG_k may extend parallel to the horizontal direction, but the disclosure is not limited thereto, and the k-th pattern group PTG_k may be inclined at an angle from the horizontal direction. For example, in the multi-view image displayed by the display device 100, there may be an optimal viewing distance corresponding to each viewpoint VW. In case that the distance between the user and the display device 100 is different from the optimal viewing distance of the image corresponding to the k-th viewpoint VWk, distortion may be generated in the image and the visibility of the display device 100 may be reduced. Accordingly, it is desirable to measure the degree of distortion in the multi-view image output by the display device 100.

Referring to FIG. 7 together, the main controller 230 (see FIG. 4) may generate the luminance profile of the measured image MI. For example, the main controller 230 may generate the luminance profile by analyzing the luminance distribution of the k-th measured image MI_k.

The main controller 230 may extract luminance profile graphs PF corresponding to the luminance profile. For example, the main controller 230 may extract first to third luminance profile graphs PF_P1, PF_P2, and PF_P3 by analyzing the luminance distribution of each of first to third parts P1 to P3 in a vertical direction in FIG. 6. Hereinafter, for convenience of description, description will focus on the second luminance profile graph PF_P2.

The second luminance profile graph PF_P2 may be a graph extracted by analyzing the luminance distribution of the second part P2 of the k-th measured image MI_k. The second luminance profile graph PF_P2 may include a first area A1 and a second area A2.

The first area A1 may be an area corresponding to an image intended to be viewed by the user at the k-th viewpoint VWk. For example, the first area A1 may be an area corresponding to the luminance distribution of the k-th pattern PTk in the second part P2.

The second area A2 may be an area corresponding to an image that is not intended to be viewed by the user at the k-th viewpoint VWk. For example, the first area A1 may be an area corresponding to the luminance distribution of the (k−1)th pattern PTk−1 and/or the (k+1)th pattern PTk+1 in the second part P2.

The main controller 230 may measure crosstalk based on a ratio of the first area A1 and the second area A2. For example, the main controller 230 may calculate areas of the first area A1 and the second area A2 of the second luminance profile graph PF_P2. The main controller 230 may extract a value obtained by dividing the area of the second area A2 by the area of the first area A1, and measure the crosstalk generated by the display device 100 based on the value. However, this is only an example, and the disclosure is not limited thereto as long as the crosstalk can be quantified.

The main controller 230 may measure the degree of distortion based on the first luminance profile graph PF_P1 adjacent to the second luminance profile graph PF_P2. For example, a second line L2 may be a virtual line that overlaps a point where luminance is maximum in the second luminance profile graph PF_P2. A first line L1 may be a virtual line that overlaps a point where luminance is maximum in the first luminance profile graph PF_P1. The main controller 230 may extract a horizontal distance WT_D between the second line L2 and the first line L1. Accordingly, the main controller 230 may measure the degree of distortion in the image output by the display device 100 based on the extracted horizontal distance WT_D. However, this is only an example, and the disclosure is not limited thereto as long as the degree of distortion can be quantified.

According to an embodiment of the disclosure, the time to measure the degree of crosstalk and distortion of the multi-view image output by the display device 100 may be shortened. For example, the luminance meter 200 may generate the measured image MI corresponding to each of the viewpoints VW through a single capture. Accordingly, the luminance meter 200 may generate the luminance profile based on the measured image MI through a single capture, and the time to measure the degree of crosstalk and distortion of the image output by the display device 100 may be shortened.

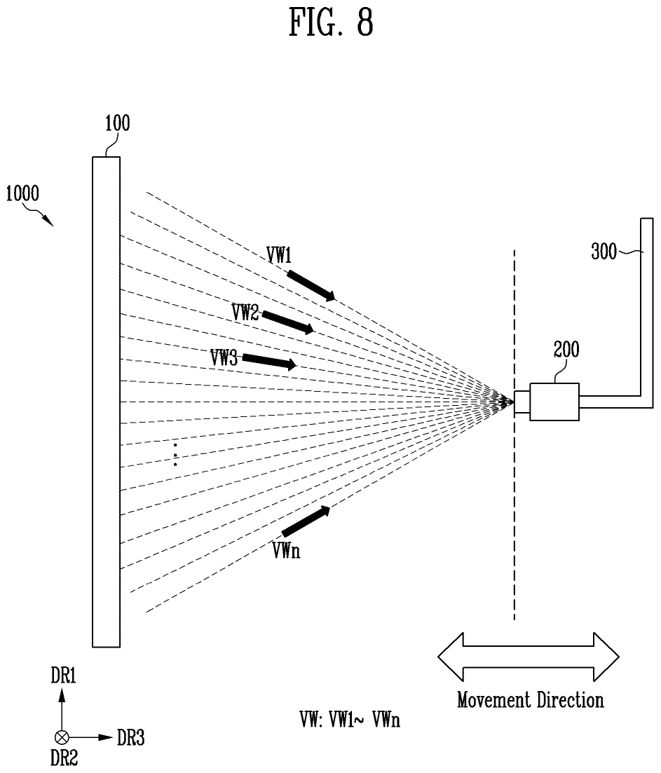

FIG. 8 is a schematic diagram illustrating a state in which the luminance meter of FIG. 3 has been moved from the display panel.

Referring to FIG. 8, the luminance meter 200 may be moved from the display device 100 by the moving member 300. For example, the luminance meter 200 may be moved in the third direction DR3 and/or in a direction opposite to the third direction DR3.

According to an embodiment of the disclosure, the system 1000 for evaluating the display device may measure the degree of crosstalk and distortion while changing a distance (for example, a distance in the third direction DR3) between the luminance meter 200 and the display device 100. For example, the moving member 300 may move the luminance meter 200 in the third direction DR3 or in a direction opposite to the third direction DR3. The luminance meter 200 may generate the luminance profile of the multi-view image displayed by the display device 100 in a state close to or away from the display device 100. Accordingly, the luminance meter 200 may measure the degree of crosstalk and distortion generated by the display device 100 depending on a distance from the display device 100.

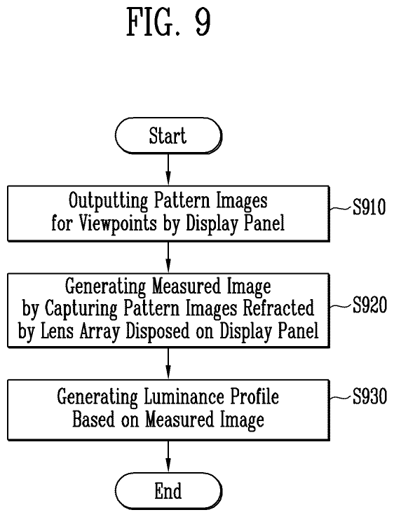

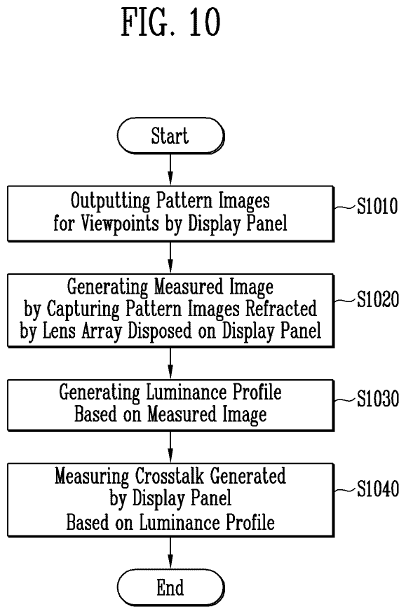

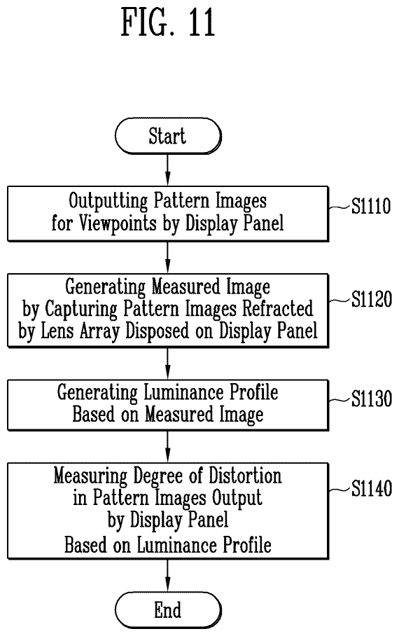

FIG. 9 is a flowchart illustrating a method for evaluating a display device according to an embodiment of the disclosure. FIG. 10 is a flowchart illustrating a method for evaluating a display device according to another embodiment of the disclosure. FIG. 11 is a flowchart illustrating a method for evaluating a display device according to still another embodiment of the disclosure.

Referring to FIG. 9, a method for evaluating a display device 100 according to an embodiment may include outputting pattern images for viewpoints by a display panel (S910), generating a measured image by capturing the pattern images refracted by a lens array disposed on the display panel (S920), and generating a luminance profile based on the measured image (S930).

Referring to FIGS. 5 and 9, in the step S910, the display panel DP may output the pattern images PI for viewpoints VW (see FIG. 3). For example, multiple sub-pixel groups of the display panel DP may output the first to n-th pattern images PI1 to PIn based on pattern signals.

The pattern images PI may correspond to different viewpoints VW. For example, the first to n-th pattern images PI1 to PIn may correspond to the first to n-th viewpoints VW1 to VWn, respectively.

Referring to FIGS. 3, 6 and 9, in the step S920, the measured image MI may be generated by capturing the pattern images PI. For example, the k-th measured image MI_k may be generated based on the captured first to n-th pattern images PI1 to PIn. The k-th measured image MI_k may correspond to an image that can be viewed by the user of the display device 100 from the k-th viewpoint VWk.

At this step, a distance between the display device 100 (see FIG. 8) and the luminance meter 200 (see FIG. 8) may vary. For example, after the luminance meter 200 is moved by the moving member 300, the pattern images PI may be captured. Accordingly, measured images MI corresponding to the pattern images PI captured at different positions may be generated.

Referring to FIGS. 7 and 9, in the step S930, the luminance profile may be generated based on the measured image MI. For example, the luminance profile based on the k-th measured image MI_k may be generated.

At this step, the luminance profile graphs PF for multiple parts of the measured image MI may be extracted. For example, the luminance profile graphs PF_P1, PF_P2, and PF_P3 may be extracted by analyzing the luminance distribution of the first to third parts P1 to P3 of the k-th measured image MI_k in the vertical direction.

Referring to FIG. 10, a method for evaluating a display device 100 according to an embodiment may include outputting pattern images for viewpoints by a display panel (S1010), generating a measured image by capturing the pattern images refracted by a lens array disposed on the display panel (S1020), generating a luminance profile based on the measured image (S1030), and measuring crosstalk generated by the display panel based on the luminance profile (S1040).

The steps S1010, S1020, and S1030 of FIG. 10 may be similar to the steps S910, S920, and S930 of FIG. 9. Hereinafter, overlapping descriptions will be omitted.

Referring to FIGS. 7 and 10, in the step S1040, crosstalk generated by the display panel DP may be measured based on the luminance profile. For example, the second luminance profile graph PF_P2 including the first area A1 and the second area A2 may be extracted. Thereafter, crosstalk may be measured based on a value obtained by dividing the area of the second area A2 by the area of the first area A1.

Referring to FIG. 11, a method for evaluating a display device 100 according to an embodiment may include outputting pattern images for viewpoints by a display panel (S1110), generating a measured image by capturing the pattern images refracted by a lens array disposed on the display panel (S1120), generating a luminance profile based on the measured image (S1130), and measuring the degree of distortion in the pattern images output by the display panel based on the luminance profile (S1140).

The steps S1110, S1120, and S1130 of FIG. 11 may be similar to the steps S910, S920, and S930 of FIG. 9. Hereinafter, overlapping descriptions will be omitted.

Referring to FIGS. 7 and 11, in the step S1140, the degree of distortion in the pattern images PI output by the display panel DP may be measured based on the luminance profile. For example, the first luminance profile graph PF_P1 and the second luminance profile graph PF_P2 may be extracted. Thereafter, the horizontal distance WT_D between a point where the first line L1 and the first luminance profile graph PF_P1 overlap and luminance is maximum and another point where the second line L2 and the second luminance profile graph PF_P1 overlap and luminance is maximum may be extracted. Based on this, the degree of distortion in the stereoscopic image output by the display panel DP may be measured.

According to the system and method for evaluating a display device according to the disclosure, the time to evaluate the display device that outputs an image corresponding to multiple viewpoints can be shortened.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A system for evaluating a display device comprising:
a display device including a display panel outputting pattern images for viewpoints and a lens array refracting the pattern images; and
a luminance meter generating a luminance profile by capturing the pattern images,
wherein each of the pattern images includes a pattern.

2. The system of claim 1, wherein the pattern images include the pattern at different positions.

3. The system of claim 2, wherein
the pattern images include a first pattern image including a first pattern and a second pattern image including a second pattern,
the first pattern overlaps a virtual reference pattern defined in the pattern images, and
the second pattern is spaced apart from the virtual reference pattern by a first distance in a direction.

4. The system of claim 3, wherein
the pattern images further include a third pattern image including a third pattern, and
the third pattern is spaced apart from the virtual reference pattern in the direction by a second distance greater than the first distance.

5. The system of claim 1, wherein the pattern has a line shape.

6. The system of claim 1, wherein the luminance meter includes a main controller measuring crosstalk generated by the display panel based on the luminance profile.

7. The system of claim 6, wherein the main controller extracts a luminance profile graph corresponding to the luminance profile, and measures the crosstalk based on a ratio of an area and another area other than the area in the luminance profile graph.

8. The system of claim 7, wherein
the area includes a point where luminance is maximum in the luminance profile graph, and
the crosstalk decreases as the area increases.

9. The system of claim 6, wherein the main controller measures a degree of distortion in the pattern images output by the display panel based on the luminance profile.

10. The system of claim 9, wherein the main controller extracts luminance profile graphs corresponding to the luminance profile, and measures the degree of distortion based on a distance between a point where luminance is maximum in one of the luminance profile graphs and a point where luminance is maximum in another adjacent one of the luminance profile graphs.

11. The system of claim 10, wherein the degree of distortion increases as the distance increases.

12. The system of claim 1, further comprising:
a moving member moving the luminance meter from the display panel.

13. A method for evaluating a display device comprising:
outputting pattern images for viewpoints by a display panel;
generating a measured image by capturing the pattern images refracted by a lens array disposed on the display panel; and
generating a luminance profile based on the measured image,
wherein each of the pattern images includes a pattern.

14. The method of claim 13, wherein the pattern images include the pattern at different positions.

15. The method of claim 13, wherein
the pattern images include a first pattern image including a first pattern and a second pattern image including a second pattern,
the first pattern overlaps a virtual reference pattern defined in the pattern images, and
the second pattern is spaced apart from the virtual reference pattern by a first distance in a direction.

16. The method of claim 15, wherein
the pattern images further include a third pattern image including a third pattern, and
the third pattern is spaced apart from the virtual reference pattern in the direction by a second distance greater than the first distance.

17. The method of claim 13, further comprising:
measuring crosstalk generated by the display panel based on the luminance profile.

18. The method of claim 17, wherein the measuring of the crosstalk comprises:
extracting a luminance profile graph corresponding to the luminance profile; and
measuring the crosstalk based on a ratio of an area and another area other than the area in the luminance profile graph.

19. The method of claim 13, further comprising:
measuring a degree of distortion in the pattern images output by the display panel based on the luminance profile.

20. The method of claim 19, wherein the measuring of the degree of distortion in the pattern images comprises:
extracting luminance profile graphs corresponding to the luminance profile; and
measuring the degree of distortion based on a distance between a point where luminance is maximum in one of the luminance profile graphs and a point where luminance is maximum in another adjacent one of the luminance profile graphs.
